(19) United States
(12) Patent Application Publication
(10) Pub. No.: US 2019/0375344 A1
(43) Pub. Date: Dec. 12, 2019

(54) BRACKET AND SENSOR DEVICE

(71) Applicant: Nidec Corporation, Kyoto (JP)

(72) Inventor: Takayuki KOBAYASHI, Kyoto (JP)

(21) Appl. No.: 16/434,258

(22) Filed: Jun. 7, 2019

(30) Foreign Application Priority Data
Jun. 8, 2018 (JP) 2018-110126
May 30, 2019 (JP) 2019-101231

(51) Int. Cl. B60R 11/04; H04N 5/225; G03B 17/55

(52) U.S. Cl. CPC B60R 11/04; H04N 5/2254; B60R 2011/0026; H04N 5/2257; G03B 17/55; H04N 5/2252

(57) ABSTRACT

A bracket fixes a sensor, which detects an outside of a vehicle, to a glass surface on a vehicle interior space side. The bracket includes a heat transfer member including a heat transfer surface extending in lateral and longitudinal directions and facing the glass surface, and a support member fixed to the heat transfer member and disposed adjacent to lateral edges and one or both of longitudinal edges of the heat transfer member. The heat transfer member is made of a metal material. In a state where the bracket is attached to the glass surface, the support member includes a contact portion that is in contact with the glass surface, the heat transfer surface and the contact portion are arranged side by side along the glass surface, and the contact portion deforms in accordance with a shape of the glass surface.

### CROSS REFERENCE TO RELATED APPLICATION

The present invention claims priority under 35 U.S.C. § 119 to Japanese Application No. 2018-110126 filed on Jun. 8, 2018 and Japanese Application No. 2019-101231 filed on May 30, 2019 the entire contents of which are incorporated herein by reference.

### 1. FIELD OF THE INVENTION

The present disclosure relates to a bracket and a sensor device.

### 2. BACKGROUND

In recent years, in the advanced driver assistance system (ADAS) field, a sensor such as a camera or a radar has been used as an on-vehicle sensor fixed to a glass surface in a vehicle interior.

In the related art on-vehicle sensor, in which the heat of a sensor is dissipated to a windshield by bringing a heat transfer member having a high thermal conductivity, such as aluminum or copper, into close contact with the windshield. However, because metal materials such as aluminum and copper are rigid and hard, the heat transfer member may hit the windshield due to vibration of the vehicle body and the windshield may become damaged. In order to avoid such a situation, it is necessary to interpose a separate soft and flexible member between the heat transfer member and the windshield. However, in such a structure, the heat transfer member cannot be brought close to the windshield. Therefore, there is a problem that heat cannot be sufficiently dissipated from the heat transfer member to the windshield.

Also, with other in the related art on-vehicle sensor, in which a heat conduction member composed of a silicone material is disposed between a bracket and a windshield. However, there is a problem that, since the bracket is formed of a resin material, the heat of the sensor is not sufficiently transmitted to the bracket, and as a result, it is difficult to release the heat of the sensor to the windshield.

### SUMMARY

Accordingly, preferred embodiments of the present invention provide brackets each capable of stably fixing a sensor to a glass surface and efficiently transmitting the heat generated by the sensor main body to the glass surface.

A bracket according to an example embodiment of the present invention is a bracket that fixes a sensor main body, which performs sensing of an outside of a vehicle, to a glass surface on a vehicle interior space side of the vehicle. The bracket includes a heat transfer member including a heat transfer surface extending in lateral and longitudinal directions and facing the glass surface, and a support member fixed to the heat transfer member and disposed adjacent to lateral edges of the heat transfer member and one or both of longitudinal edges of the heat transfer member. The heat transfer member is made of a metal material. The support member includes a contact portion that is in contact with the glass surface in a state where the bracket is attached to the glass surface. The heat transfer surface and the contact portion are arranged side by side along the glass surface in a state where the bracket is attached to the glass surface. The contact portion deforms in accordance with a shape of the glass surface in a state where the bracket is attached to the glass surface.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 is a schematic sectional view of a vehicle equipped with a sensor device according to an example embodiment of the present invention.

FIG. 2 is an exploded perspective view of the sensor device.

FIG. 3 is a side view of the sensor device.

### DETAILED DESCRIPTION

Hereinafter, a bracket 3 and a sensor device 2 according to example embodiments of the present disclosure will be described with reference to the drawings. Further, in the following drawings, in order to make each configuration easy to understand, there are cases where actual scales, numbers and the like in the respective structures differ from the actual structures.

In the following description, a vehicle width direction of a vehicle 1 when the sensor device 2 is attached to the vehicle 1 is taken as the width direction or the left-right direction of the sensor device 2, and the up-down direction of the vehicle 1 is taken as the up-down direction of the sensor device 2. Further, the orientations and positions of members of the sensor device 2 are examples, and can be changed within a range that does not deviate from the meaning of this disclosure.

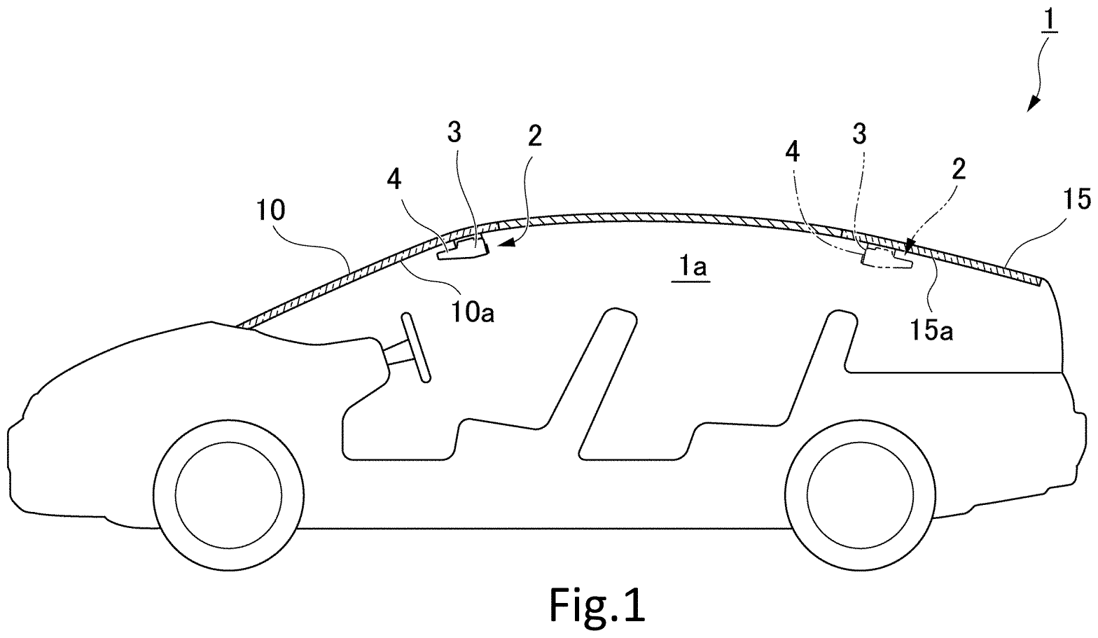

FIG. 1 is a schematic sectional view of the vehicle 1 equipped with the sensor device 2. The vehicle 1 has a windshield 10, which is a window glass facing forward, and a rear glass 15, which is a window glass facing rearward. In addition, the vehicle 1 is provided with a vehicle interior space 1a located between the windshield 10 and the rear glass 15 in a front-rear direction. The vehicle interior space 1a is a living space for passengers riding in the vehicle 1. In addition, the vehicle interior space 1a is also a space where luggage can be loaded. In the present example embodiment, the vehicle interior space 1a is a space isolated from the outside of the vehicle 1. In the case where the ceiling of the vehicle 1 is open, the vehicle interior space 1a may be a space exposed to the outside of the vehicle 1.

The vehicle 1 has a drive mechanism (not illustrated). The drive mechanism includes an engine, a steering mechanism, a power transmission mechanism, wheels, and the like. In addition, an electric motor may be used instead of the engine.

Further, the vehicle 1 of this example embodiment is an example. The vehicle is not limited to a passenger car, and may be a truck, a train, or the like.

The sensor device 2 is attached to a glass surface 10a on a vehicle interior space 1a side of the windshield 10 and is used to perform sensing of the outside of the vehicle (specifically, in front of the vehicle 1).

Further, the sensor device 2 may be attached to a glass surface 15a of the rear glass 15 on the vehicle interior space 1a side as indicated by a two-dot chain line in FIG. 1. When the sensor device 2 is attached to the rear glass 15, the sensor device 2 is used to perform sensing of the rear of the vehicle 1.

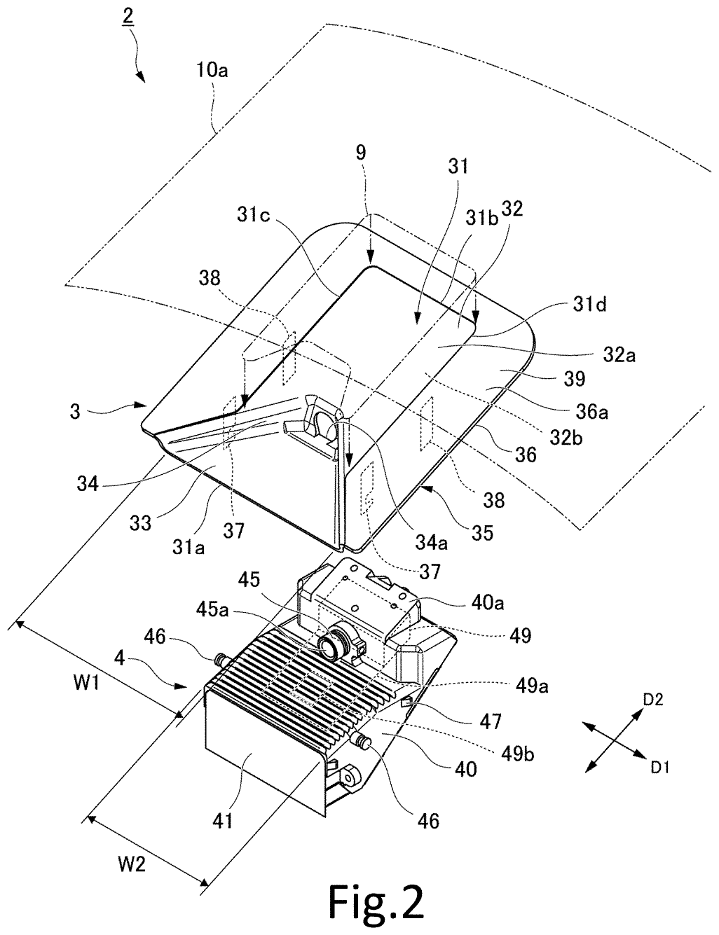

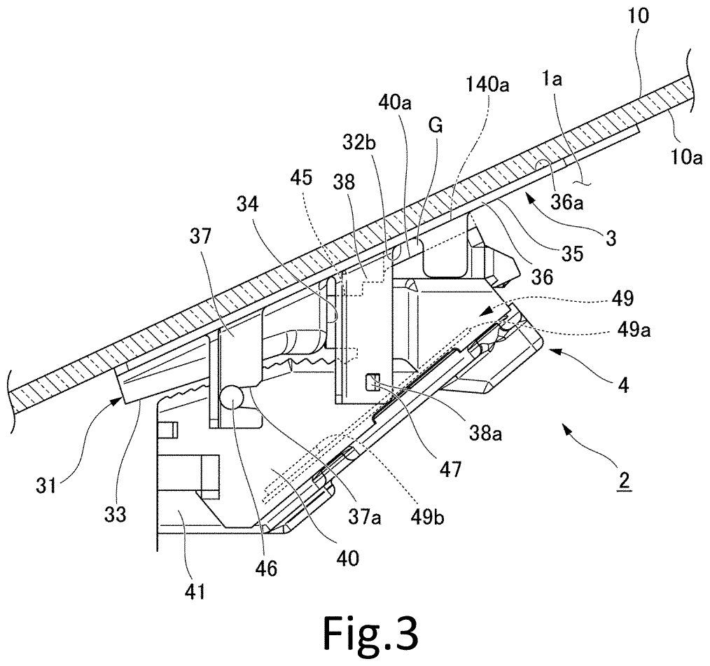

FIG. 2 is a perspective view of the sensor device 2. FIG. 3 is a side view of the sensor device 2. Further, in FIG. 2, the sensor device 2 is in a state in which it is disassembled into a sensor main body 4 and the bracket 3.

As illustrated in FIG. 2, the sensor device 2 includes the sensor main body 4 and the bracket 3. In addition, the sensor device 2 may also include an outer cover fixed to the bracket 3 to protect the sensor main body 4.

The sensor main body 4 of the present example embodiment is of the fusion type including a radar device 41 and an imaging device 45. The sensor main body 4 is fixed to the bracket 3.

The sensor main body 4 includes a case 40, the radar device 41, the imaging device 45, and a control unit 49. The control unit 49 controls the radar device 41 and the imaging device 45. The control unit 49 includes a substrate 49a and an integrated circuit 49b mounted on a top surface of the substrate 49a.

The case 40 houses the radar device 41, the imaging device 45, and the control unit 49. The case 40 is formed of a metal material composed of aluminum or an aluminum alloy. The case 40 may be formed of a plurality of members.

The radar device 41, the imaging device 45 and the control unit 49 are fixed to the case 40. In addition, at least a portion of the electronic elements forming the radar device 41, the imaging device 45, and the control unit 49 directly contact the case 40. Therefore, some of the heat generated by the radar device 41, the imaging device 45, and the control unit 49 is transmitted to the case 40.

Further, the electronic elements forming the radar device 41, the imaging device 45, and the control unit 49 may be in contact with the case 40 indirectly via a member having a high thermal conductivity. For example, a member such as a thermally conductive sheet or thermally conductive grease may be interposed in a portion where the electronic elements and the case 40 are in contact with each other. With this configuration, the adhesion between the electronic elements and the case 40 is enhanced and heat conduction is promoted. Even in this case, the heat generated from the electronic elements is actively transmitted to the case 40.

The case 40 has an upper end surface 40a facing upward. The upper end surface of the case 40 is located immediately above the area in which the control unit 49 is housed. The upper end surface 40a faces the glass surface 10a with the bracket 3 interposed therebetween. As illustrated in FIG. 3, the upper end surface 40a opposes the bracket 3 in the up-down direction with a gap G interposed therebetween.

Further, as a modification of the present example embodiment, an upper end surface 140a may adopt a configuration in which it is in contact with the bracket 3. More specifically, the upper end surface 140a of the modification is in contact with a heat transfer member 31 of the bracket 3 described later.

As illustrated in FIG. 2, the case 40 has a pair of shaft portions 46 extending in the left-right direction and a pair of claw portions 47 projecting in the left-right direction. The shaft portions 46 and the claw portions 47 are individually provided on the left side and the right side of the case 40. The claws portions 47 are disposed rearward of the shaft portions 46. As described later, the case 40 is supported by the bracket 3 at the shaft portions 46 and the claw portions 47.

The radar device 41 avoids a collision with an obstacle or the like, and assists the driver in driving. The radar device 41 emits millimeter waves to the front or rear of the vehicle 1. The radar device 41 receives the radar waves reflected by an object to be measured, and detects the distance to the object to be measured and the direction of the object to be measured.

The imaging device 45 is a camera that captures a scene in front of or behind the vehicle. The imaging device 45 includes a lens 45a and an imaging element (not illustrated) located behind the lens 45a. The lens 45a has an optical axis in the front-rear direction. The imaging element captures an image of a subject formed through a lens as image data. The imaging device 45 may be connected to a storage device via the control unit 49. In this case, the image captured by the imaging device 45 is stored in the storage device.

The bracket 3 is used to fix the sensor main body 4 to the glass surface 10a on the vehicle interior space 1a side of the vehicle 1. The bracket 3 is fixed to the glass surface 10a of the windshield 10. In addition, the bracket 3 supports the case 40 of the sensor main body 4. The bracket 3 sets the attachment orientation of the sensor main body 4 with respect to the glass surface 10a.

The bracket 3 is fixed to a predetermined position of the windshield 10, for example, on a portion of the glass surface 10a near a rearview mirror. The bracket 3 supports the sensor main body 4 such that the sensor main body 4 is oriented along the glass surface 10a. In this example embodiment, the case where the bracket 3 is used to fix the sensor main body 4 to the glass surface 10a on the vehicle interior space 1a side of the vehicle 1 is illustrated; however, the bracket 3 may be used to fix the sensor main body 4 to the glass surface 15a on the vehicle interior space 1a side of the rear glass 15.

The bracket 3 has the heat transfer member 31 and a support member 35. The heat transfer member 31 and the support member 35 are fixed to each other. The bracket 3 transfers the heat generated by the sensor main body 4 to the glass surface 10a via the heat transfer member 31. The bracket 3 is fixed to the glass surface 10a via the support member 35. In addition, the bracket 3 supports the sensor main body 4 via the support member 35.

The heat transfer member 31 is formed of a metal material. Generally, metal materials have a higher thermal conductivity than resin materials. By forming the heat transfer member 31 from a metal material, heat can be efficiently absorbed from the sensor main body 4 via the heat transfer member 31, and heat can be efficiently dissipated to the glass surface 10a. More preferably, the heat transfer member 31 is formed of aluminum or an aluminum alloy, which has a high thermal conductivity and is relatively inexpensive among metal materials. The heat transfer member 31 is formed by, for example, pressing.

The heat transfer member 31 includes a heat transfer portion 32, a flange portion 33 and a step portion 34.

The heat transfer portion 32 is in the form of a flat plate extending along the glass surface 10a. The heat transfer portion 32 has a substantially rectangular shape in plan view. The heat transfer portion 32 includes a heat transfer surface 32a facing the glass surface 10a. That is, the heat transfer member includes the heat transfer surface 32a. The heat transfer member 31 transfers heat to the glass surface 10a via the heat transfer surface 32a.

The heat transfer surface 32a extends in a lateral direction D1 and a longitudinal direction D2.

Further, in the present specification, the lateral direction D1 and the longitudinal direction D2 are directions in a plane of a predetermined surface. In the present specification, the lateral direction D1 is a direction that coincides with the width direction of the vehicle. In addition, in the present specification, the longitudinal direction D2 is a direction perpendicular to the lateral direction D1 in the plane of the heat transfer surface 32a.

The heat transfer surface 32a of the present example embodiment is a surface in which the dimension thereof in the longitudinal direction D2 is larger than the dimension thereof in the lateral direction D1. Generally, the glass surface 10a is a concave surface that is recessed toward the vehicle outer side. In addition, the glass surface 10a generally has a smaller curvature in the longitudinal direction D2 than in the lateral direction D1. That is, the glass surface 10a is a curved surface that is almost flat in the longitudinal direction D2. Therefore, by lengthening the heat transfer surface 32a in the longitudinal direction D2, the entirety of the heat transfer surface 32a can be disposed close to the glass surface 10a.

Further, although the heat transfer surface 32a of the present example embodiment is a flat surface, the heat transfer surface 32a may be a convex surface following the concave shape of the glass surface 10a. That is, the heat transfer surface 32a may be flat or convex.

As indicated by a two-dot chain line in FIG. 2, a heat transfer sheet 9 may be disposed between the heat transfer surface 32a and the glass surface 10a. That is, the bracket 3 may have the heat transfer sheet 9 disposed between the heat transfer surface 32a and the glass surface 10a. One surface of the heat transfer sheet 9 contacts the glass surface 10a. In addition, the other surface of the heat transfer sheet 9 contacts the heat transfer surface 32a.

The heat transfer sheet 9 is preferably a material having high flexibility and thermal conductivity. The heat transfer sheet is composed of, for example, a silicone material. The heat transfer sheet 9 is attached to the heat transfer surface 32a using, for example, an adhesive.

The curvature of the concave surface of the glass surface 10a differs depending on the vehicle type. For this reason, when attaching one type of the bracket 3 to the vehicle 1 of any of various types, it is difficult to bring the heat transfer surface 32a into close contact with the glass surface 10a. According to the present example embodiment, the heat transfer sheet 9 is disposed between the heat transfer surface 32a and the glass surface 10a. Thus, the heat transfer surface 32a can be in close contact with the glass surface 10a with the heat transfer sheet 9 therebetween. That is, according to the present example embodiment, a wide contact area between the heat transfer surface 32a and the glass surface 10a with the heat transfer sheet 9 therebetween can be secured, and heat transfer from the heat transfer surface 32a to the glass surface 10a can be promoted.

The heat transfer portion 32 has a lower surface 32b facing downward. The lower surface 32b is a surface facing in the opposite direction to the heat transfer surface 32a. The lower surface 32b faces the upper end surface 40a of the case 40. The lower surface 32b is a surface parallel to the upper end surface 40a. As illustrated in FIG. 3, the lower surface 32b faces the upper end surface 40a with the gap G therebetween. That is, the heat transfer member 31 and the sensor main body 4 face each other in the up-down direction with the gap G interposed therebetween. According to the present example embodiment, by providing the gap G between the heat transfer member 31 and the sensor main body 4, flexibility in positioning the sensor main body 4 with respect to the bracket 3 can be enhanced. As a result, the mounting angle of the sensor main body 4 with respect to the vehicle 1 can be adjusted, and the sensor main body 4 can be mounted in various types of vehicle in an appropriate orientation. In addition, according to the present example embodiment, because the upper end surface 40a of the case 40 is exposed, the heat of the sensor main body 4 can be dissipated by heat radiation. That is, even if the lower surface 32b of the heat transfer portion 32 and the upper end surface 40a of the case 40 are not in close contact with each other, the heat radiation effect by heat radiation can be increased.

In FIG. 3, the upper end surface 140a of the modification is indicated by an imaginary line (two-dot chain line). The upper end surface 140a of the modification is located upward relative to the upper end surface 40a. In this case, the lower surface 32b is in contact with the upper end surface 140a. In the present modification, the heat transfer member 31 is in contact with the sensor main body 4. The heat of the sensor main body 4 is transmitted to the heat transfer member 31 at a contact portion between the upper end surface 140a and the lower surface 32b.

Further, another member having high thermal conductivity may be interposed between the upper end surface 140a and the lower surface 32b. In this case, the other intervening member can be regarded as part of the case 40.

According to this modification, because the heat transfer member 31 contacts the upper end surface 140a of the sensor main body 4, heat can be efficiently transmitted from the sensor main body 4 to the heat transfer member 31. Consequently, according to the present example embodiment, the heat of the sensor main body 4 can be efficiently transmitted to the glass surface 10a through the heat transfer member 31, and the heat can be effectively dissipated from the sensor main body 4 to the glass surface 10a.

As illustrated in FIG. 2, the flange portion 33 is located in front of the heat transfer portion 32. The flange portion 33 has a substantially triangular shape which becomes wider as it goes forward. The flange portion 33 is in the form of a flat plate not parallel to the heat transfer portion 32.

The flange portion 33 extends in front of the lens 45a. The flange portion 33 has a shape in which the width increases toward the front. Because it has such a shape, the flange portion 33 can secure a sufficient angle of view for the imaging device 45 (for example, 100°, at least 90° or more).

The flange portion 33 extends along the top surface of the case 40. The flange portion 33 is connected to the heat transfer portion 32 via the step portion 34. According to the present example embodiment, by providing the heat transfer member 31 with the flange portion 33, the heat generated by the sensor main body 4 can be released to the outside through the flange portion 33.

As shown in FIG. 3, the substrate 49a disposed in the case 40 extends forward, and the front edge of the substrate 49a reaches below the flange portion 33. Furthermore, the integrated circuit 49b having a larger amount of heat generation than the other mounted components is mounted in a front region of the substrate 49a. The integrated circuit 49b is at least partially located below the flange portion 33. The flange portion 33 releases the heat generated by the integrated circuit 49b to the outside.

As shown in FIG. 2, a width dimension W1 of the front end of the flange portion 33 is larger than a width dimension W2 of the front end of the sensor main body 4. Here, the width dimensions W1 and W2 are dimensions in a lateral direction D1. By making the width dimension W1 of the front end of the flange portion 33 sufficiently larger than the width dimension W2 of the front end of the sensor main body 4, the region in front of the sensor main body 4 can be covered with the flange portion 33. In the present example embodiment, the integrated circuit 49b is disposed in the front region in the case 40. By covering the area in front of the sensor main body 4 from the upper side, the flange portion 33 can efficiently dissipate the heat generated by the integrated circuit 49b in the flange portion 33.

Further, the shape of the flange portion 33 is not limited to this example embodiment. The flange portion 33 may be any of various other forms as long as it extends in front of the lens 45a and does not obstruct the field of view of the lens 45a.

The step portion 34 is located between the heat transfer portion 32 and the flange portion 33 and connects the front edge of the heat transfer portion 32 and the rear edge of the flange portion 33 to each other. The rear edge of the flange portion 33 is located farther from the glass surface than the front edge of the heat transfer portion 32. Consequently, the step portion 34 has a shape that widens in the up-down direction. In a state where the flange portion 33 is viewed in plan, the step portion 34 forms portions of left and right sides of an isosceles triangle having the lens 45a as a vertex. Consequently, the step portion 34 has an L shape. A window 34a penetrating in the front-rear direction is provided at the left-right-direction center of the step portion 34. The lens 45a of the sensor main body 4 is exposed to the front through the window 34a.

The support member 35 is formed of a resin material. The support member 35 is formed, for example, by injection molding. In the present example embodiment, the support member 35 is integrally formed with the heat transfer member 31. That is, the bracket 3 is manufactured by insert molding.

The support member 35 is fixed to the heat transfer member 31. The support member 35 is disposed adjacent to one edge (rear edge 31b) of a pair of edges 31a and 31b in the longitudinal direction D2 of the heat transfer member 31. In addition, the support member 35 is disposed adjacent to a pair of edges 31c and 31d in the lateral direction D1 of the heat transfer member 31. That is, the support member 35 surrounds the rear and both the left and right sides of the heat transfer member 31.

Further, the support member 35 may be disposed adjacent to the edges 31c and 31d in the lateral direction D1 of the heat transfer member 31 and one or both of the edges 31a and 31b in the longitudinal direction D2 of the heat transfer member 31.

The support member 35 includes a plate-like portion 36, a pair of first leg portions 37, and a pair of second leg portions 38.

The plate-like portion 36 is in the form of a flat plate extending substantially parallel to the heat transfer portion 32. The plate-like portion 36 is substantially U-shaped in plan view. The plate-like portion 36 includes a contact surface (contact portion) 36a facing the glass surface 10a. That is, the support member 35 includes a contact surface 36a. The contact surface 36a is in contact with the glass surface 10a in a state where the bracket 3 is attached to the glass surface 10a.

The contact surface 36a extends in the lateral direction D1 and the longitudinal direction D2. In the present example embodiment, the contact surface 36a is a flat surface parallel to the heat transfer surface 32a. The contact surface 36a is disposed on the glass surface 10a side of the heat transfer surface 32a. That is, a step is provided between the contact surface 36a and the heat transfer surface 32a. The heat transfer surface 32a is located below the contact surface 36a. The heat transfer surface 32a and the contact surface 36a are arranged side by side along the glass surface 10a in a state where the bracket 3 is attached to the glass surface 10a.

The contact surface 36a is, in plan view, disposed adjacent to one edge (rear edge) of a pair of edges of the heat transfer portion 32 in the longitudinal direction D2. The contact surface 36a is, in plan view, disposed adjacent to a pair of edges of the heat transfer portion 32 in the lateral direction D1. In the present example embodiment, the contact surface 36a is a flat surface. However, the contact surface 36a may be a convex surface following the concave shape of the glass surface 10a.

In the present example embodiment, the support member 35 is in surface contact with the glass surface 10a via the contact surface 36a. However, the support member 35 may have a contact portion that is in contact with the glass surface 10a. The regions where the contact portion (the contact surface 36a in the present example embodiment) of the support member 35 contacts the glass surface 10a may be a plurality (three or more) of points or a plurality (two or more) of lines.

An adhesive layer 39 is provided on the contact surface 36a. The support member 35 comes into contact with the glass surface 10a with the adhesive layer 39 therebetween. Thereby, the support member 35 is fixed to the glass surface 10a. The adhesive layer 39 is, for example, a film having adhesiveness.

According to the present example embodiment, since the support member 35 is formed of a resin material, bending rigidity is lower than when the support member 35 is formed of a metal material. Therefore, by pressing the contact surface 36a to the glass surface 10a side, the contact surface 36a easily deforms following the shape of the glass surface 10a. According to this example embodiment, the contact area and the adhesion area of the support member 35 and the glass surface 10a can be sufficiently secured, and the fixation of the bracket 3 to the glass surface 10a can be stabilized.

Further, in the present example embodiment, a case where the support member 35 is formed of a resin material is illustrated. However, the material of the support member 35 is not limited as long as the flexural rigidity of the plate-like portion 36 is sufficiently low and the contact surface 36a deforms following the shape of the glass surface 10a. As an example, the support member 35 may be a rubber material.

As described above, the heat transfer surface 32a is provided on the heat transfer portion 32 that is plate-like, and the contact surface 36a is provided on the plate-like portion 36. In addition, the heat transfer member 31 including the heat transfer surface 32a is formed of a metal material, and the support member 35 including the heat transfer surface 32a is formed of a resin material. Therefore, the plate-like portion 36 provided with the contact surface 36a has a lower bending rigidity than the heat transfer portion 32 provided with the heat transfer surface 32a. That is, when a force in the direction in which the heat transfer surface 32a and the contact surface 36a bend is applied to the bracket 3, the amount of deflection of the support member becomes larger than the amount of deflection of the heat transfer member 31. Thereby, the contact area and the adhesion area of the support member 35 and the glass surface 10a can be more effectively enlarged, and the fixation of the bracket 3 to the glass surface 10a can be stabilized.

According to the bracket 3 of the present example embodiment, the heat transfer member 31 that radiates the heat of the sensor main body 4 and the support member 35 to be fixed to the glass surface 10a are provided. Therefore, even if the glass surface 10a is a curved surface, the bracket 3 can be stably fixed to the glass surface 10a, and the heat generated by the sensor main body 4 can be efficiently transmitted to the glass surface 10a.

The first leg portions 37 and the second leg portions 38 project downward from the plate-like portion 36. The first leg portions 37 and the second leg portions 38 have a plate shape, the thickness direction of which is in the left-right direction. The pair of the first leg portions 37 are arranged symmetrically with respect to each other in the bracket 3. Similarly, the pair of second leg portions 38 are arranged symmetrically with respect to each other in the bracket 3. The second leg portions 38 are disposed rearward of the first leg portions 37.

As illustrated in FIG. 3, the first leg portions 37 are each provided with a notch 37a that opens rearward and extends forward. The shafts 46 of the case 40 are inserted into the notches 37a. The second leg portions 38 are each provided with a through hole 38a penetrating in the left-right direction. The claw portions 47 of the case 40 are inserted into the through holes 38a. The bracket 3 supports the sensor main body 4 via the first leg portions 37 and the second leg portions 38.

Although various example embodiments of the present disclosure have been described above, each configuration and each combination thereof in each example embodiment is an example, and additions, omissions, substitutions and other modifications of the configuration are possible as long as they do not depart from the spirit of the present disclosure. For example, in the above-mentioned example embodiment, although the sensor main body is of the fusion type, which has a radar device and an imaging device, it is not restricted to this. The sensor main body may be of a type that has only an imaging device and that does not have a radar device. In addition, the present disclosure is not limited by the example embodiments.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A bracket that fixes a sensor main body, which performs sensing of an outside of a vehicle, to a glass surface on a vehicle interior space side of the vehicle, the bracket comprising:
a heat transfer member including a heat transfer surface extending in lateral and longitudinal directions and facing the glass surface; and
a support member fixed to the heat transfer member and disposed adjacent to lateral edges of the heat transfer member and one or both of longitudinal edges of the heat transfer member; wherein
the heat transfer member is made of a metal material;
the support member includes a contact portion that is in contact with the glass surface in a state where the bracket is attached to the glass surface;
the heat transfer surface and the contact portion are arranged side by side along the glass surface; and
the contact portion deforms in accordance with a shape of the glass surface in a state where the bracket is attached to the glass surface.

2. The bracket according to claim 1, wherein when a force in a direction in which the heat transfer surface and the contact portion bend is applied to the bracket, an amount of deflection of the support member is larger than an amount of deflection of the heat transfer member.

3. The bracket according to claim 1, wherein the heat transfer member is made of aluminum or an aluminum alloy.

4. The bracket according to claim 1, wherein the support member is made of a resin material.

5. The bracket according to claim 1, further comprising:
a heat transfer sheet disposed between the heat transfer surface and the glass surface; wherein
a first surface of the heat transfer sheet is in contact with the glass surface; and
a second surface of the heat transfer sheet is in contact with the heat transfer surface.

6. The bracket according to claim 1, wherein the heat transfer member is in contact with the sensor main body.

7. The bracket according to claim 1, wherein the heat transfer member and the sensor main body are opposed to each other in an up-down direction with a gap therebetween.

8. The bracket according to claim 1, wherein the heat transfer surface is a flat surface, and a dimension thereof in the longitudinal direction is larger than a dimension thereof in the lateral direction.

9. The bracket according to claim 1, wherein the heat transfer member includes:
a heat transfer portion that has a flat plate shape and that is provided with the heat transfer surface;
a flange portion that is located in front of the heat transfer portion and that has a flat plate shape which expands in width toward the front; and
a step portion connecting the heat transfer portion and the flange portion; wherein
a rear edge of the flange portion is located farther from the glass surface than a front edge of the heat transfer portion; and
the step portion connects the rear edge of the flange portion and the front edge of the heat transfer portion to each other.

10. The bracket according to claim 6, wherein the heat transfer member includes:
a heat transfer portion that has a flat plate shape and that is provided with the heat transfer surface;
a flange portion that is located in front of the heat transfer portion and that has a flat plate shape that widens toward the front; and
a step portion connecting the heat transfer portion and the flange portion; wherein
a rear edge of the flange portion is located farther from the glass surface than a front edge of the heat transfer portion; and
the step portion connects the rear edge of the flange portion and the front edge of the heat transfer portion to each other.

11. The bracket according to claim 7, wherein the heat transfer member includes:
a heat transfer portion that has a flat plate shape and that is provided with the heat transfer surface;
a flange portion that is located in front of the heat transfer portion and that has a flat plate shape that widens toward the front; and
a step portion connecting the heat transfer portion and the flange portion; wherein
a rear edge of the flange portion is located farther from the glass surface than a front edge of the heat transfer portion; and
the step portion connects the rear edge of the flange portion and the front edge of the heat transfer portion to each other.

12. A sensor device comprising:
the bracket according to claim 1; and
the sensor main body fixed to the bracket.
